(19) United States
(12) Patent Application Publication
(10) Pub. No.: US 2023/0259827 A1
(43) Pub. Date: Aug. 17, 2023

(54) COMPUTER-READABLE RECORDING MEDIUM STORING GENERATION PROGRAM, GENERATION METHOD, AND INFORMATION PROCESSING DEVICE

(71) Applicant: FUJITSU LIMITED, Kawasaki-shi (JP)

(72) Inventors: Takashi KATOH, Kawasaki (JP); Kento UEMURA, Kawasaki (JP); Suguru YASUTOMI, Kawasaki (JP); Tomohiro HAYASE, Kawasaki (JP)

(73) Assignee: FUJITSU LIMITED, Kawasaki-shi (JP)

(21) Appl. No.: 18/301,582

(22) Filed: Apr. 17, 2023

Related U.S. Application Data
(63) Continuation of application No. PCT/JP2020/041750, filed on Nov. 9, 2020.

(51) Int. Cl. G06N 20/00

(52) U.S. Cl. CPC G06N 20/00

(57) ABSTRACT

A non-transitory computer-readable recording medium stores a generation program for causing a computer to execute a process including: with data included in each of a plurality of data sets, training a feature space in which a distance between pieces of the data included in a same domain is shorter and the distance of the data between different domains is longer; and generating labeled data sets by integrating labeled data included within a predetermined range in the trained feature space, among a plurality of pieces of the labeled data.

### CROSS-REFERENCE TO RELATED APPLICATION

This application is a continuation application of International Application PCT/JP2020/041750 filed on Nov. 9, 2020 and designated the U.S., the entire contents of which are incorporated herein by reference.

### FIELD

The embodiments discussed herein are related to a generation program, a generation method, and an information processing device.

### BACKGROUND

In deep learning (DL), machine learning, and the like, supervised training using labeled data, unsupervised training using unlabeled data, and semi-supervised training using both of labeled data and unlabeled data are utilized. Usually, unlabeled data has relatively low cost to collect and is easy to collect, but labeled data involves a huge amount of time and cost to collect a sufficient amount of data.

Japanese Laid-open Patent Publication No. 2019-159576 is disclosed as related art.

### SUMMARY

According to an aspect of the embodiments, a non-transitory computer-readable recording medium stores a generation program for causing a computer to execute a process including: with data included in each of a plurality of data sets, training a feature space in which a distance between pieces of the data included in a same domain is shorter and the distance of the data between different domains is longer; and generating labeled data sets by integrating labeled data included within a predetermined range in the trained feature space, among a plurality of pieces of the labeled data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining analysis of data sets;

FIG. 2 is a diagram explaining a reference technique for labeling;

FIG. 3 is a diagram explaining a reference technique for labeling;

FIG. 4 is a diagram explaining processing of an information processing device according to a first embodiment;

FIG. 5 is a functional block diagram illustrating a functional configuration of the information processing device according to the first embodiment;

FIG. 6 is a diagram explaining an example of a labeled data set;

FIG. 7 is a diagram explaining an example of an unlabeled data set;

FIG. 8 is a diagram explaining machine learning of a feature

generation model;

FIG. 9 is a diagram explaining repetition of machine learning of the feature generation model;

FIG. 10 is a diagram explaining projection into a feature space;

FIG. 11 is a diagram explaining an approach 1 for generating a labeled data set;

FIG. 12 is a diagram explaining an approach 2 for generating a labeled data set;

FIG. 13 is a diagram explaining an approach 3 for generating a labeled data set;

FIG. 14 is a diagram explaining the approach 3 for generating a labeled data set;

FIG. 15 is a diagram explaining the approach 3 for generating a labeled data set;

FIG. 16 is a diagram explaining an example of selection of analysis objects;

FIG. 17 is a flowchart illustrating a flow of processing; and

FIG. 18 is a diagram explaining a hardware configuration example.

### DESCRIPTION OF EMBODIMENTS

In recent years, it is known to generate labeled data from unlabeled data by manually attaching labels, or to generate labeled data from unlabeled data using a data converter, simulator, or the like.

However, with the above technique, discrepancies between the generated labeled data and the actual data sometimes occur at the data generation stage or due to the generation approach, which may deteriorate the quality of the labeled data.

In one aspect, an object is to provide a generation program, a generation method, and an information processing device capable of expanding a high-quality labeled data set.

Hereinafter, embodiments of a generation program, a generation method, and an information processing device will be described in detail with reference to the drawings. Note that the present embodiments are not limited to the following embodiments. In addition, the embodiments can be appropriately combined with each other unless otherwise contradicted.

### First Embodiment

### [Description of Information Processing Device]

In recent years, in various types of machine learning such as deep learning, there has been a demand for analyzing properties of a classification model, such as the accuracy, with respect to a plurality of data sets (data sets of a plurality of domains) having different types of data distribution (properties). For example, when a model is applied to a data set having data distribution (property) different from the data distribution of a labeled data set usable for machine learning (training), there is a demand for estimating (evaluating) the accuracy of the target to which the model is to be applied in advance.

In such a case, for example, an estimation object such as the accuracy for a classification model is estimated by collecting data sets of a plurality of domains made up of labeled data, measuring indices such as distribution differences between the data sets, and the estimation objects, and analyzing the relationships between the measured indices and estimation objects.

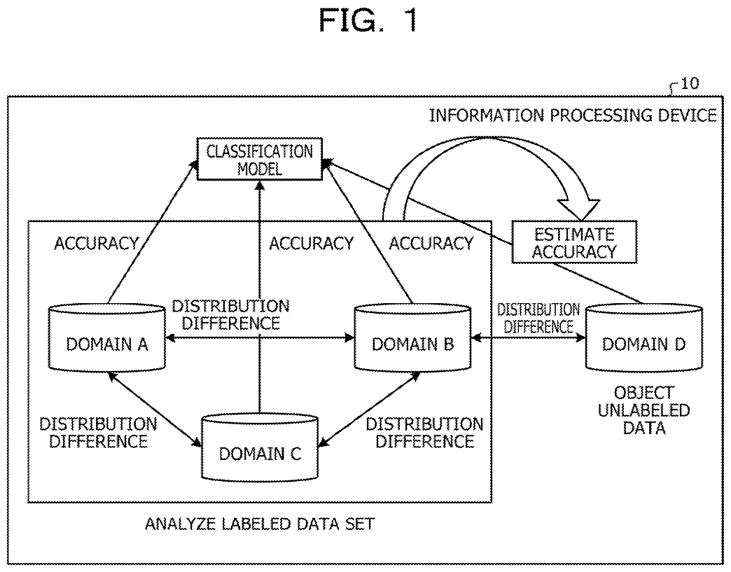

FIG. 1 is a diagram explaining analysis of data sets. As illustrated in FIG. 1, an information processing device 10 inputs each of the labeled data set of a domain A, the labeled data set of a domain B, and the labeled data set of a domain C to an object classification model and measures the classification accuracy of the classification model. Note that the labeled data set is a set of data with labels to which labels that are correct answer information are attached. In addition, the accuracy denotes the classification accuracy by the classification model, and the rate or the like of successful classification in all data can be employed.

In addition, the information processing device 10 measures the distribution of data for each of the labeled data set of the domain A, the labeled data set of the domain B, and the labeled data set of the domain C and calculates each distribution difference. Note that, as the distribution, the distribution of features for each piece of data or the variance of the features for each piece of data obtained by using, for example, another model that generates features, the distribution or variance of information obtained from the real data (such as the size, color, shape, and orientation of the image as an example), or the like can be employed.

Then, the information processing device 10 generates indices of the accuracy of the classification model from the existing labeled data sets. For example, an example of generating the index for the domain A will be described. The information processing device 10 uses accuracy A and distribution A for the domain A and accuracy B (accuracy B<accuracy A) and distribution B for the domain B to calculate a distribution difference A1 (distribution A−distribution B) and an accuracy difference A1 (accuracy A−accuracy B). Similarly, the information processing device 10 uses the accuracy A and the distribution A for the domain A and accuracy C (accuracy A<accuracy C) and distribution C for the domain C to calculate a distribution difference A2 (distribution A−distribution C) and an accuracy difference A2 (accuracy C−accuracy A). As a result, based on the relationship between the accuracy of the domain A and each classification difference, the information processing device 10 can generate an index as to how much difference from the distribution of the domain A produces how much degradation or improvement from the accuracy of the domain A.

In this manner, the information processing device 10 generates indices for each of the domains A, B, and C with reference to each domain.

As another example, the information processing device 10 also can generate indices by linear interpolation in a two-dimensional space of accuracy and distribution. For example, the information processing device 10 plots the accuracy A and the distribution A of the domain A, the accuracy B and the distribution B of the domain B, and the accuracy C and the distribution C of the domain C in a two-dimensional space of distribution and index. Then, by performing interpolation using an existing technique such as linear interpolation with reference to these three points, the information processing device 10 can generate an index for estimating the accuracy from the distribution.

Thereafter, the information processing device 10 calculates distribution D of data of a domain D when applying the classification model to the unlabeled data set of the domain D. Then, the information processing device 10 can estimate accuracy D corresponding to the distribution D of the domain D, which is an evaluation object (accuracy estimation object), in accordance with the index for estimating the accuracy from the distribution described above.

In addition, when the domain D is known to be related to the domain B, the information processing device 10 uses the distribution D of the domain D and the distribution B of the domain B to calculate a distribution difference D1. Then, the information processing device 10 can estimate the accuracy D corresponding to the distribution D of the domain D, which is an evaluation object, using the distribution difference D1 and the accuracy B of the domain B.

As described above, by using existing labeled data sets, the information processing device 10 can, for example, predict the accuracy beforehand when applying a classification model to a new environment. In addition, when such cross-domain analysis for labeled data is performed, labeled data for a plurality of domains (labeled domains) have to be collected, and the more existing labeled data sets, the more improved the prediction accuracy.

However, unlabeled data has relatively low cost to collect and is easy to collect, but labeled data involves a huge amount of time and cost to collect a sufficient amount of data.

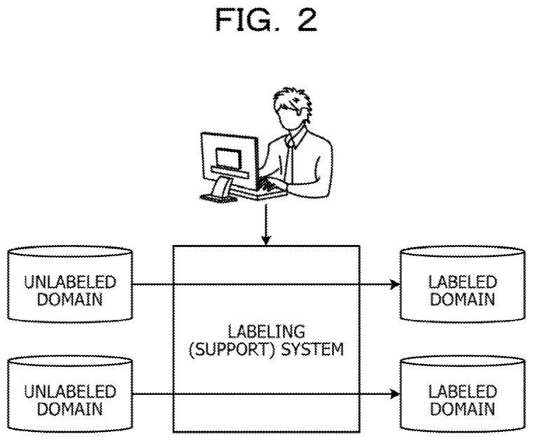

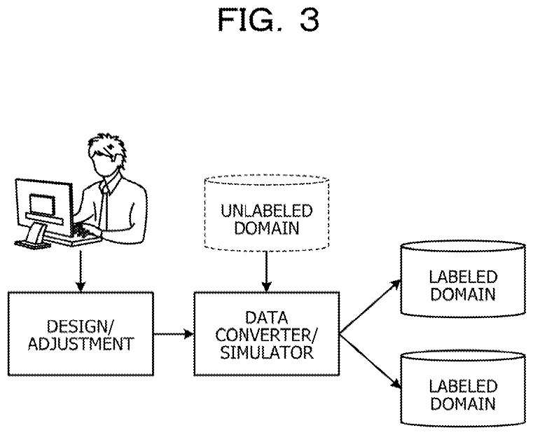

FIGS. 2 and 3 are diagrams explaining reference techniques for labeling. As illustrated in FIG. 2, labeled domains are generated by manually attaching labels to unlabeled data (unlabeled domains). This approach is costly due to manual intervention. In addition, as illustrated in FIG. 3, users design data converters, simulators, or the like according to the properties or the like of data to directly generate labeled domains. This approach involves manual design and relies on the design, which will sometimes cause discrepancies between the generated labeled data and the actual data. In this manner, highly accurate analysis is not allowed with few labeled domains or poor-quality labeled domains.

Thus, in a first embodiment, data of a plurality of labeled domains is mixed to generate a new labeled domain (pseudo-domain). For example, the information processing device 10 uses unlabeled domains that are easy to collect to generate a feature space for domains to determine the mixing method.

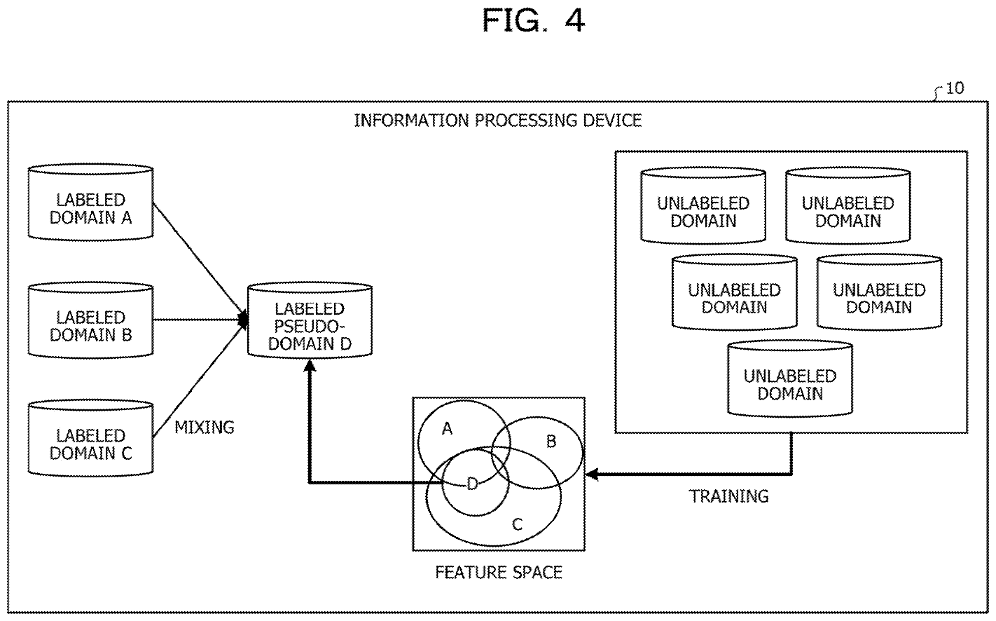

FIG. 4 is a diagram explaining processing of the information processing device 10 according to the first embodiment. As illustrated in FIG. 4, for a plurality of data sets made up of unlabeled data (each piece of data included in unlabeled domains), the information processing device 10 trains (performs metric learning on) a feature space in which the distance between pieces of data included in the same domain is shorter and the distance of data between different domains is longer. Then, the information processing device 10 projects each piece of data of a labeled domain A, a labeled domain B, and a labeled domain C into the feature space and collects the labeled data included in a subspace within the feature space, thereby generating a new labeled domain (pseudo-domain D). Note that, when the unlabeled data is insufficient, a part of the labeled data may be used as the unlabeled data.

In this manner, since the labeled data set of a new domain can be generated using real data, the information processing device 10 may expand a high-quality labeled data set. As a result, the information processing device 10 may expand the labeled data set used for inter-domain relationship analysis and also may improve the analysis accuracy.

### [Functional Configuration]

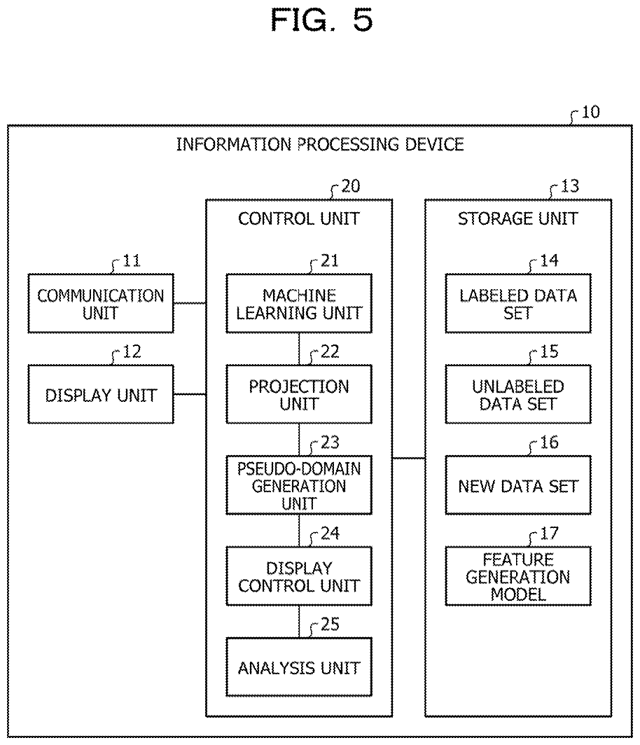

FIG. 5 is a functional block diagram illustrating a functional configuration of the information processing device 10 according to the first embodiment. As illustrated in FIG. 5, the information processing device 10 includes a communication unit 11, a display unit 12, a storage unit 13, and a control unit 20.

The communication unit 11 is a processing unit that controls communication with another device and, for example, is implemented by a communication interface or the like. For example, the communication unit 11 receives training data, analysis objects, various instructions, and the like from an administrator terminal. In addition, the communication unit 11 transmits an analysis result and the like to the administrator terminal.

The display unit 12 is a processing unit that displays various types of information and, for example, is implemented by a display, a touch panel, or the like. For example, the display unit 12 displays pseudo-domains and analysis results, which will be described later, and the like.

The storage unit 13 is a processing unit that stores various types of data, programs executed by the control unit 20, and the like and, for example, is implemented by a memory, a hard disk, or the like. This storage unit 13 stores a labeled data set 14, an unlabeled data set 15, a new data set 16, and a feature generation model 17.

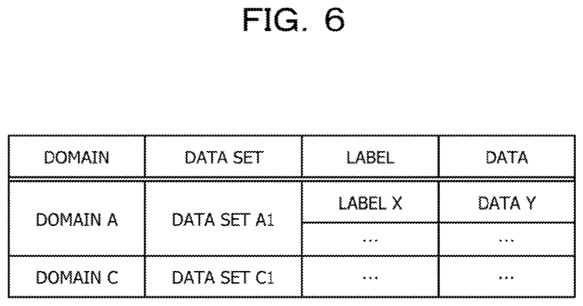

The labeled data set 14 stores a plurality of data sets constituted by labeled data. FIG. 6 is a diagram explaining an example of the labeled data set 14. As illustrated in FIG. 6, the labeled data set 14 stores “domain, data set, label, and data” in association with each other. The “domain” denotes a domain to which the data set belongs, the “data set” denotes a data set belonging to the domain, the “label” denotes the correct answer information, and the “data” denotes data belonging to the data set.

The example in FIG. 6 indicates that a data set A1 belongs to a domain A, and the data set A1 has teacher data in which a label X and data Y are associated. In addition, it is indicated that a data set C1 belongs to a domain C. Note that the labeled data of the data set A belonging to the domain A will be sometimes expressed as data of a labeled domain A, and the data set A that is labeled and belongs to the domain A will be sometimes expressed as a labeled domain A.

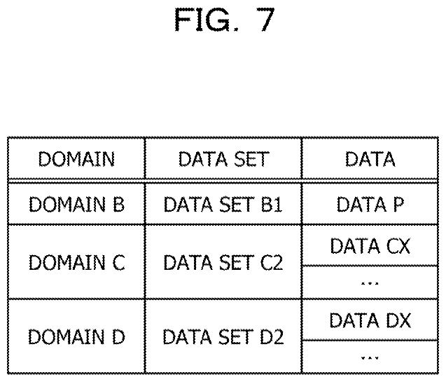

The unlabeled data set 15 stores a plurality of data sets constituted by unlabeled data. FIG. 7 is a diagram explaining an example of the unlabeled data set 15. As illustrated in FIG. 7, the unlabeled data set 15 stores “domain, data set, and data” in association with each other. The “domain” denotes a domain to which the data set belongs, the “data set” denotes a data set belonging to the domain, and the “data” denotes data belonging to the data set.

The example in FIG. 7 indicates that a data set B1 belongs to a domain B, and the data set B1 includes data P, and indicates that a data set C2 belongs to a domain C, and the data set C2 includes data CX. In addition, it is indicated that a data set D2 belongs to a domain D, and the data set D2 includes data DX. For example, the domain C includes the labeled data set and the unlabeled data set. Note that the unlabeled data of the data set C belonging to the domain C will be sometimes expressed as data of an unlabeled domain C, and the data set C that is unlabeled and belongs to the domain C will be sometimes expressed as an unlabeled domain C.

The new data set 16 is a data set generated by the control unit 20, which will be described later. For example, the new data set 16 corresponds to a pseudo-domain. Note that the details will be described later. The feature generation model 17 is a machine learning model that generates features from input data. This feature generation model 17 is generated by the control unit 20, which will be described later. Note that the feature generation model 17 generated by another device can also be used.

The control unit 20 is a processing unit that exercises overall control of the information processing device 10 and, for example, is implemented by a processor or the like. This control unit 20 includes a machine learning unit 21, a projection unit 22, a pseudo-domain generation unit 23, a display control unit 24, and an analysis unit 25. Note that the machine learning unit 21, the projection unit 22, the pseudo-domain generation unit 23, the display control unit 24, and the analysis unit 25 are implemented by electronic circuits included in the processor, processes executed by the processor, and the like.

The machine learning unit 21 is a processing unit that generates the feature generation model 17 by machine learning using a plurality of pieces of unlabeled data. For example, the machine learning unit 21 executes metric learning using unlabeled data to execute learning (training) of the feature space of the feature generation model 17 and stores the trained feature generation model 17 in the storage unit 13. For example, with data included in each of a plurality of data sets, the machine learning unit 21 trains a feature space in which the distance between pieces of data included in the same domain is shorter and the distance of data between different domains is longer. Note that labeled data may be used for learning (training), but it is more effective to use unlabeled data, which costs less to collect.

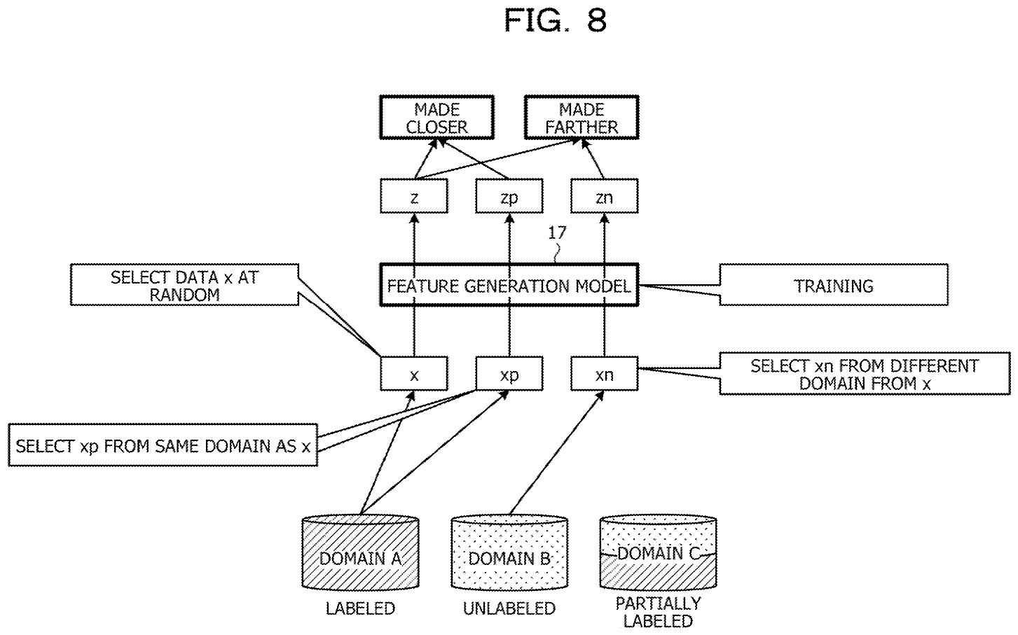

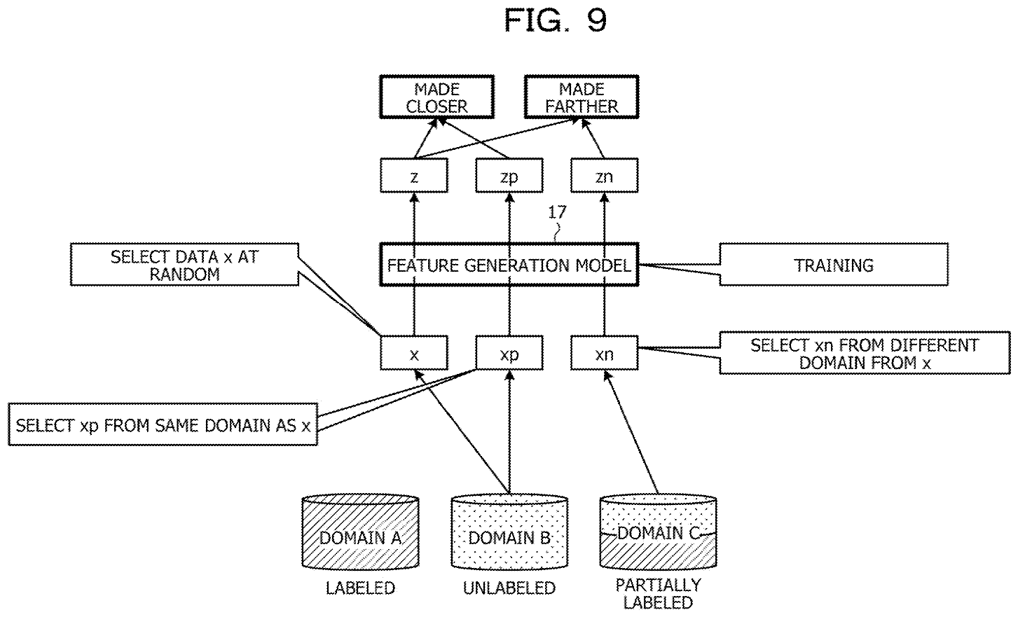

FIG. 8 is a diagram explaining machine learning of the feature generation model 17, and FIG. 9 is a diagram explaining repetition of machine learning of the feature generation model 17. As illustrated in FIG. 8, the machine learning unit 21 acquires labeled data x and labeled data xp from the labeled data set of the domain A and also acquires unlabeled data xn from the unlabeled data set of the domain B. Subsequently, the machine learning unit 21 inputs the labeled data x, the labeled data xp, and the unlabeled data xn to the feature generation model 17 and generates features z, zp, and zn, respectively.

Thereafter, the machine learning unit 21 trains the feature space such that the distance between the features z and zp generated from the same domain is made shorter, and additionally, the distance between the features z and zn generated from different domains is made farther. For example, the machine learning unit 21 performs training regarding triplet loss so as to minimize a loss function L calculated using formula (1). Note that a preset constant is denoted by a.

### [Mathematical Formula 1]

L=(z−zp)\hat{ }2−(z−zn)\hat{ }2+a Formula (1)

In addition, as illustrated in FIG. 9, the machine learning unit 21 acquires unlabeled data x and unlabeled data xp from the unlabeled data set of the domain B and also acquires unlabeled data xn from the unlabeled data set of the domain C. Subsequently, the machine learning unit 21 inputs the unlabeled data x, the unlabeled data xp, and the unlabeled data xn to the feature generation model 17 and generates features z, zp, and zn, respectively. Thereafter, the machine learning unit 21 trains the feature space such that the distance between the features z and zp generated from the same domain is made shorter, and additionally, the distance between the features z and zn generated from different domains is made farther.

The projection unit 22 is a processing unit that projects a plurality of pieces of labeled data into the trained feature space. For example, the projection unit 22 inputs each piece of data of the labeled data set 14 used for machine learning of the feature generation model 17 to the trained feature generation model 17 and projects each input piece of data into the trained feature space.

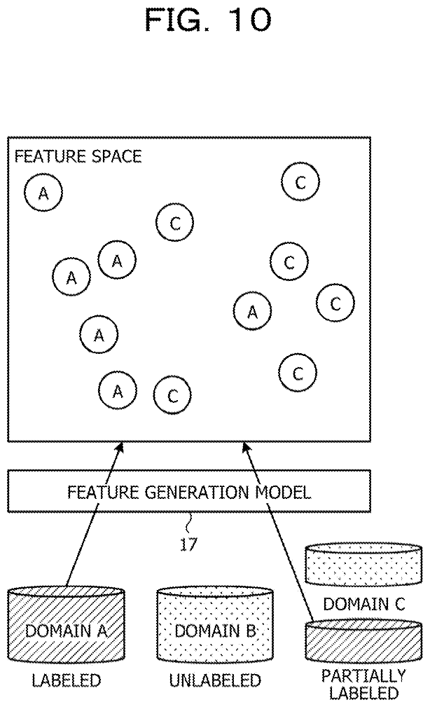

FIG. 10 is a diagram explaining projection into the feature space. As illustrated in FIG. 10, the projection unit 22 acquires each piece of data A from the data set A of the domain A that is labeled to project each acquired piece of the data A into the trained feature space and acquires each piece of data C from the data set C of the domain C that is labeled to project each acquired piece of the data C into the trained feature space. Note that, in the feature space in FIG. 10, the features expressed as A indicate that they are features of data belonging to the domain A, and the features expressed as C indicate that they are features of data belonging to the domain C.

The pseudo-domain generation unit 23 is a processing unit that generates a labeled data set by integrating labeled data included within a predetermined range (subspace) in the trained feature space, among a plurality of pieces of labeled data. For example, the pseudo-domain generation unit 23 combines the labeled data of a known domain projected into the feature space to generate a labeled data set of a pseudo-domain generated in a pseudo manner and stores the generated labeled data set as the new data set 16 in the storage unit 13.

### (Approach 1)

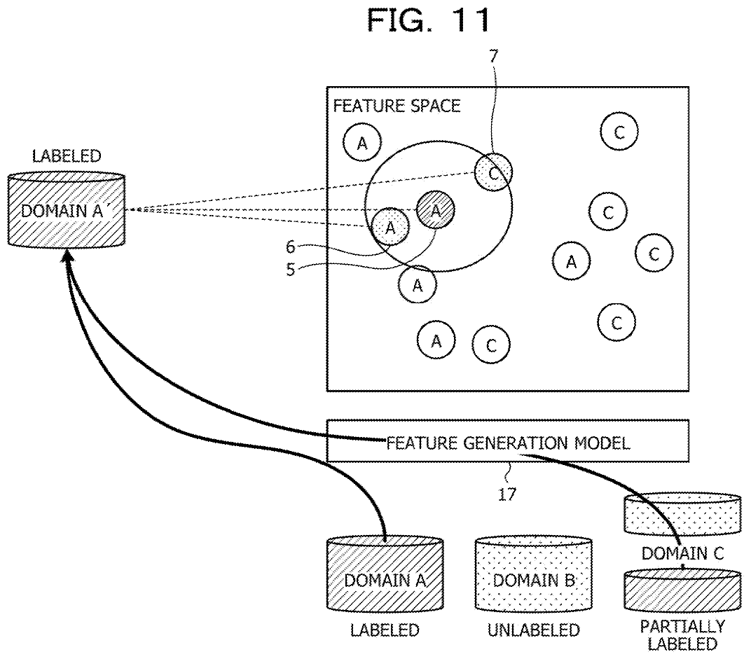

The pseudo-domain generation unit 23 integrates k pieces of labeled data (k-neighborhood) close to a point within a subspace of the feature space to generate a new data set of the pseudo-domain. FIG. 11 is a diagram explaining an approach 1 for generating a labeled data set. As illustrated in FIG. 11, the pseudo-domain generation unit 23 selects a feature A5 as an arbitrary point from the feature space after the labeled data is projected by the projection unit 22. Then, the pseudo-domain generation unit 23 specifies features A6 and C7 located within a predetermined distance from the feature A5.

Thereafter, the pseudo-domain generation unit 23 acquires data corresponding to the specified features A5 and A6 from the existing labeled data set of the domain A and acquires data corresponding to the specified feature C7 from the existing labeled data set of the domain C. Then, since the arbitrary point (A5) is data belonging to the domain A, the pseudo-domain generation unit 23 generates a labeled data set of a pseudo-domain A′ including each acquired piece of the data.

### (Approach 2)

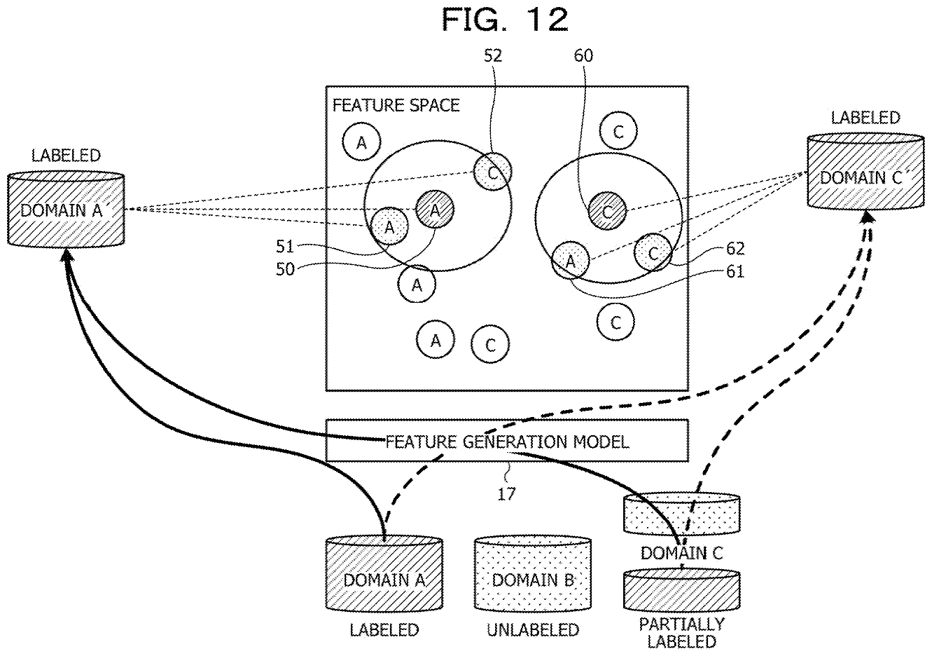

The pseudo-domain generation unit 23 selects a plurality of arbitrary points from the feature space and acquires and integrates a predetermined number of pieces of labeled data located within a predetermined distance from the selected points for each of the plurality of points, thereby generating labeled data sets individually corresponding to each of the plurality of points. FIG. 12 is a diagram explaining an approach 2 for generating a labeled data set. As illustrated in FIG. 12, the pseudo-domain generation unit 23 selects features A50 and C60 as arbitrary points from the feature space after the labeled data is projected by the projection unit 22.

Then, the pseudo-domain generation unit 23 specifies features A51 and C52 located within a predetermined distance from the feature A50. Thereafter, the pseudo-domain generation unit 23 acquires respective pieces of data corresponding to the specified features A51 and C52 from the existing labeled data set of the domain A and the existing labeled data set of the domain C. Then, since the arbitrary point (A50) is data belonging to the domain A, the pseudo-domain generation unit 23 generates a labeled data set of a pseudo-domain A′ including each acquired piece of the data.

Similarly, the pseudo-domain generation unit 23 specifies features A61 and C62 located within a predetermined distance from the feature C60. Thereafter, the pseudo-domain generation unit 23 acquires respective pieces of data corresponding to the specified features A61 and C62 from the existing labeled data set of the domain A and the existing labeled data set of the domain C. Then, since the arbitrary point (C60) is data belonging to the domain C, the pseudo-domain generation unit 23 generates a labeled data set of a pseudo-domain C′ including each acquired piece of the data.

### (Approach 3)

The pseudo-domain generation unit 23 projects each piece of object data of the unlabeled data set corresponding to a first domain that is an object to be applied to the classification model, into the trained feature space, and integrates labeled data located within a predetermined distance from each piece of the object data in the trained feature space, thereby generating a labeled data set corresponding to the pseudo-domain of the first domain.

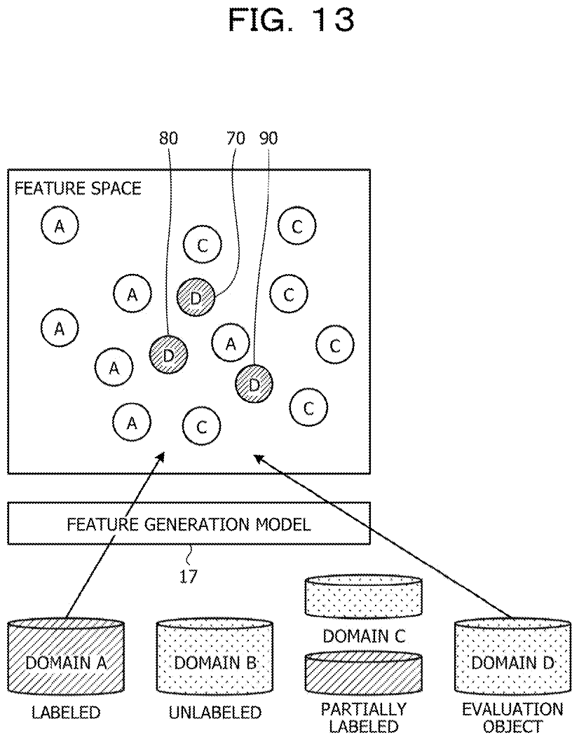

FIGS. 13, 14, and 15 are diagrams explaining an approach 3 for generating a labeled data set. As illustrated in FIG. 13, after the labeled data is projected by the projection unit 22, the pseudo-domain generation unit 23 or the projection unit 22 acquires each piece of data D from a data set D of an evaluation object domain D that is unlabeled to project each acquired piece of the data D into the trained feature space. Note that FIG. 13 illustrates an example in which three pieces of the data D are projected as an example.

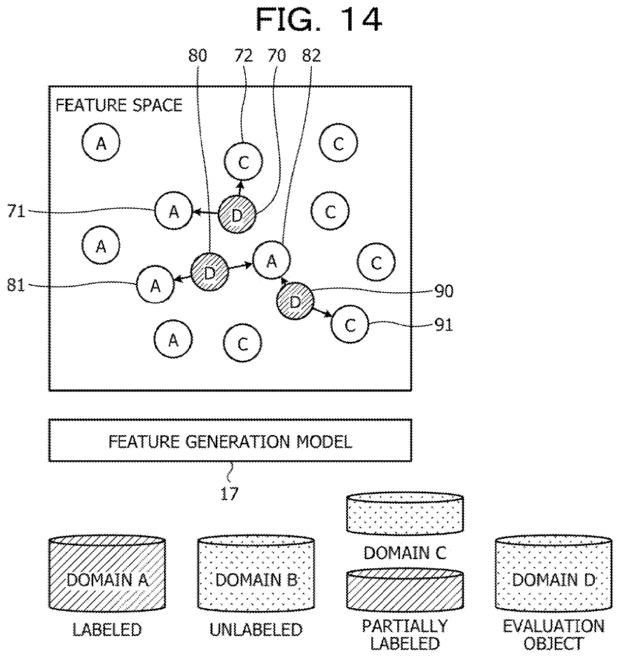

Subsequently, as illustrated in FIG. 14, the pseudo-domain generation unit 23 specifies features A71 and C72 located within a predetermined distance from a feature D70 of the projected data D, specifies features A81 and A82 located within a predetermined distance from a feature D80 of the projected data D, and specifies a feature C91 located within a predetermined distance from a feature D90 of the projected data D.

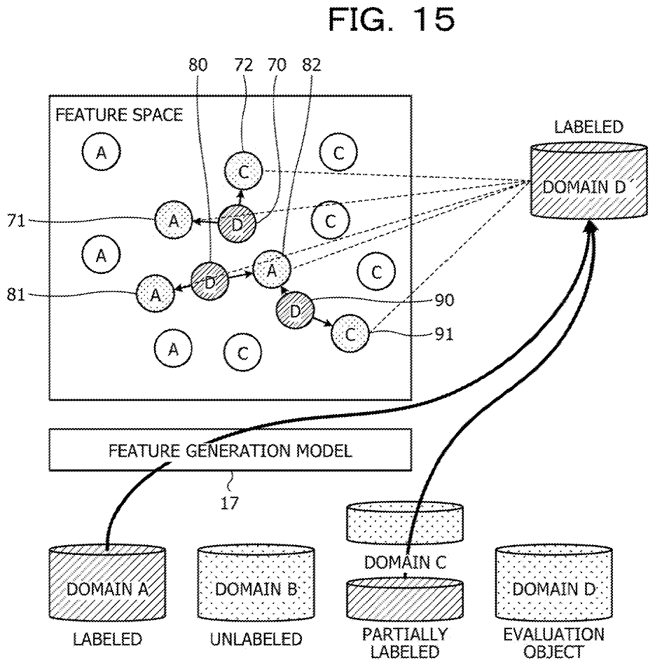

Thereafter, as illustrated in FIG. 15, the pseudo-domain generation unit 23 acquires respective pieces of data corresponding to the specified features A71, A81, and A82 from the existing labeled data set of the domain A. In addition, the pseudo-domain generation unit 23 acquires respective pieces of data corresponding to the specified features C72 and C91 from the existing labeled data set of the domain C. Then, since the object to be applied is the domain D, the pseudo-domain generation unit 23 generates a labeled data set of a pseudo-domain D′ including each acquired piece of the data.

Returning to FIG. 5, the display control unit 24 is a processing unit that outputs and displays various types of information to and on the display unit 12. For example, the display control unit 24 outputs and displays the new data set 16 generated by the pseudo-domain generation unit 23 to and on the display unit 12. In addition, the display control unit 24 outputs and displays the analysis result executed by the analysis unit 25, which will be described later, to and on the display unit 12.

The analysis unit 25 is a processing unit that executes the analysis process described with reference to FIG. 1 to execute an analysis of an existing data set in order to evaluate the evaluation object data set. For example, the analysis unit 25 uses a plurality of labeled data sets to calculate the accuracy, distribution difference, and the like of each data set. In addition, the analysis unit 25 uses the accuracy and distribution difference corresponding to the labeled data set to evaluate (estimate) the accuracy with respect to the evaluation object unlabeled data set before applying the unlabeled data set to the classification model.

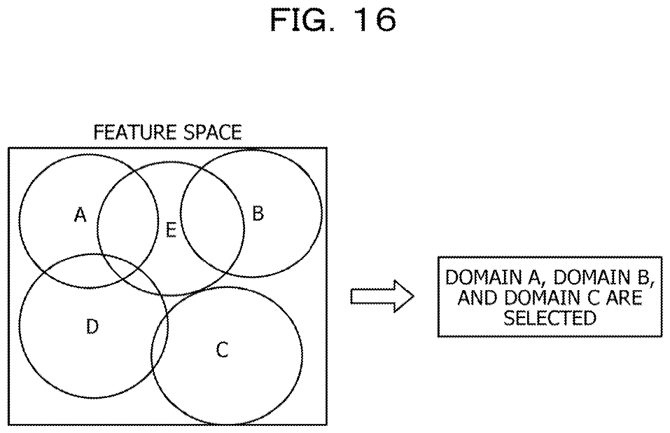

For example, the analysis unit 25 selects, as analysis objects, a set of labeled data sets whose overlapping spaces are equal to or less than a threshold value and whose coverage in the trained feature space is equal to or higher than a threshold value, from among a plurality of labeled data sets (pseudo-domains) generated using the trained feature space. FIG. 16 is a diagram explaining an example of selection of analysis objects. It is assumed that respective data sets of domains A, B, C, D, and E are generated as pseudo-domains, as illustrated in FIG. 16.

In this case, the analysis unit 25 specifies that the domain A overlaps the two domains D and E, the domain B overlaps the one domain E, and the domain C overlaps the one domain D in the feature space. Similarly, the analysis unit 25 specifies that the domain D overlaps the three domains A, C, and E, and the domain E overlaps the three domains A, B, and D.

As a result, the analysis unit 25 selects the domains A, B, and C whose number of overlaps is equal to or less than the threshold value (2), as analysis objects. At this time, the analysis unit 25 can also consider the coverage in the feature space. For example, the analysis unit 25 specifies the center point that is the center of the subspace of the domain A and the most distant end point from the center point and calculates the area of the subspace of the domain A by the area of a circle whose radius is the distance from the center point to the end point.

In this manner, the analysis unit 25 calculates the respective areas of the domains A, B, and C, which are analysis candidates, and calculates the total area by summing the respective areas. Then, if the total area is equal to or greater than a threshold value, the analysis unit 25 can select the analysis candidates as they are as analysis objects and, if the total area is smaller than the threshold value, can also further select another domain. Meanwhile, if the area of the feature space is calculable or known, the analysis unit 25 calculates “coverage=(total area/area of feature space)×100”. If the coverage is equal to or higher than a threshold value, the analysis unit 25 can select analysis candidates as they are as analysis objects and, if the coverage is lower than the threshold value, can also further select another domain.

In addition, the analysis unit 25 can also select the labeled data set generated based on an evaluation object first data set, as an analysis object, from among the plurality of labeled data sets generated using the trained feature space. For example, in the case of FIG. 15, when the domain D is the evaluation object, the analysis unit 25 selects a pseudo-domain D′ generated by projecting each piece of data of the domain D, as the analysis object. At this time, the analysis unit 25 can also, for example, delete any piece of data of the domain D included in the pseudo-domain D′ or add data of any other domain that is not included in the pseudo-domain D′. Note that the analysis object does not have to be one, and a plurality of selections can be made.

### [Flow of Processing]

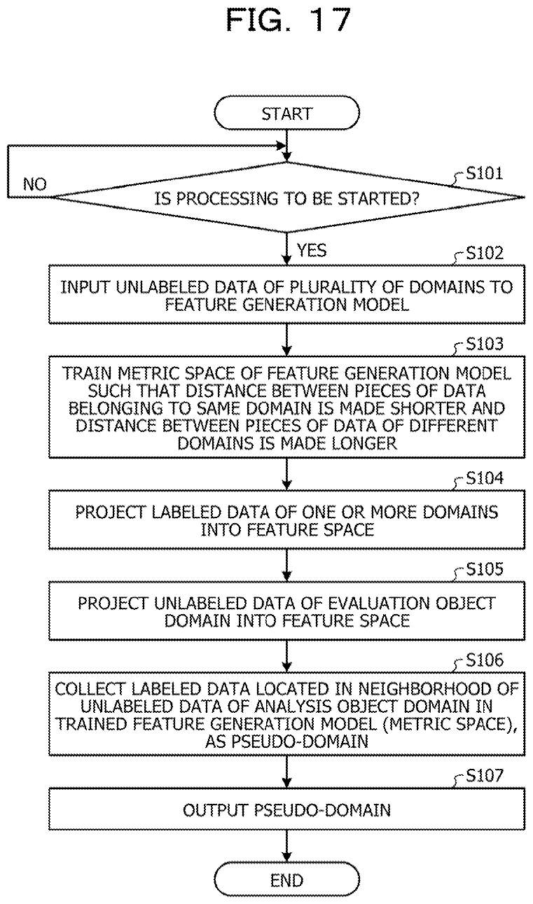

FIG. 17 is a flowchart illustrating a flow of processing. Here, the aforementioned approach 3 will be described as an example.

As illustrated in FIG. 17, when instructed to start processing (S101: Yes), the machine learning unit 21 inputs each piece of unlabeled data of a plurality of domains to the feature generation model 17 (S102). Then, the machine learning unit 21 trains a metric space in which the distance between pieces of data belonging to the same domain is shorter and the distance between pieces of data of different domains is longer (S103).

After the training of the metric space is completed, the projection unit 22 inputs each piece of labeled data of one or more labeled data sets to the feature generation model 17 to project the features into the feature space (S104). Then, the pseudo-domain generation unit 23 inputs the unlabeled data of the evaluation object domain to the feature generation model 17 to project the features into the feature space (S105).

Then, the pseudo-domain generation unit 23 collects labeled data located in the neighborhood of the unlabeled data of the estimation object domain in the trained metric space, as a pseudo-domain (S106), and outputs the collected labeled data as a data set of the pseudo-domain (S107).

### [Effects]

As described above, the information processing device 10 can generate labeled data of a new domain similar to the real domain from real data.

As a result, the information processing device 10 may execute the analysis process using high-quality labeled data and may improve the accuracy of analysis and the efficiency of analysis.

In addition, since the information processing device 10 can generate the labeled data of a domain that matches the real data, from easily available unlabeled data without high-cost human intervention, the accuracy of analysis and the efficiency of analysis may be improved while the cost is reduced. In addition, since the information processing device 10 trains the feature space by executing machine learning of the feature generation model 17, a feature space that achieves both of short time and high accuracy may be generated.

In addition, since the information processing device 10 can select an arbitrary point from the trained feature space and generate a labeled data set obtained by integrating a predetermined number of pieces of labeled data located within a predetermined distance from the arbitrary point, a labeled data set suitable for user needs may be generated by arbitrary point selection approaches. In addition, since the information processing device 10 can select a plurality of arbitrary points from the trained feature space and generate a plurality of labeled data sets, a plurality of analysis object labeled data sets may be generated at high speed.

In addition, the information processing device 10 projects each piece of object data of the unlabeled data set corresponding to the evaluation object domain into the trained feature space. Then, the information processing device 10 can generate a labeled data set corresponding to the pseudo-domain by integrating labeled data located within a predetermined distance from each piece of the object data in the trained feature space. As a result, since the information processing device 10 can execute the analysis of accuracy using data similar to the evaluation object, the reliability of the analysis may be improved.

In addition, the information processing device 10 can select, as analysis objects, a set of labeled data sets whose overlapping spaces are equal to or less than a threshold value and whose coverage in the trained feature space is equal to or higher than a threshold value, from among a plurality of labeled data sets. As a result, since the information processing device 10 can generate a pseudo-domain that covers the entire feature space, the analysis accuracy may also be improved.

### Second Embodiment

Incidentally, while the embodiments have been described above, the embodiments may be carried out in a variety of different modes in addition to the embodiments described above.

### [Data, Numerical Values, etc.]

A data example, a numerical value example, a threshold value, a display example, the number of dimensions of the feature space, a domain name, the number of domains, and the like used in the above embodiments are merely examples and may be optionally modified. In addition, use for analysis of voice and time-series data or the like is possible in addition to the image classification using image data as training data.

### [Analysis Process]

In the above embodiments, an example in which the information processing device 10 executes the analysis process has been described, but the embodiments are not limited to this, and another device apart from the information processing device 10 can also execute the analysis process using the analysis result. In addition, the contents of the analysis process are also an example, and other known analysis approaches can be employed.

### [System]

Pieces of information including the processing procedure, control procedure, specific name, and various types of data and parameters described above or illustrated in the drawings can be optionally modified unless otherwise noted. Note that the machine learning unit 21 is an example of a machine learning unit, and the pseudo-domain generation unit 23 is an example of a generation unit.

In addition, each component of each device illustrated in the drawings is functionally conceptual and does not necessarily have to be physically configured as illustrated in the drawings. For example, specific forms of distribution and integration of the respective devices are not limited to those illustrated in the drawings. For example, all or a part of the devices can be configured by being functionally or physically distributed or integrated in optional units according to various loads, use situations, or the like.

Furthermore, all or an optional part of the individual processing functions performed in each device can be implemented by a central processing unit (CPU) and a program analyzed and executed by the CPU, or can be implemented as hardware by wired logic.

### [Hardware]

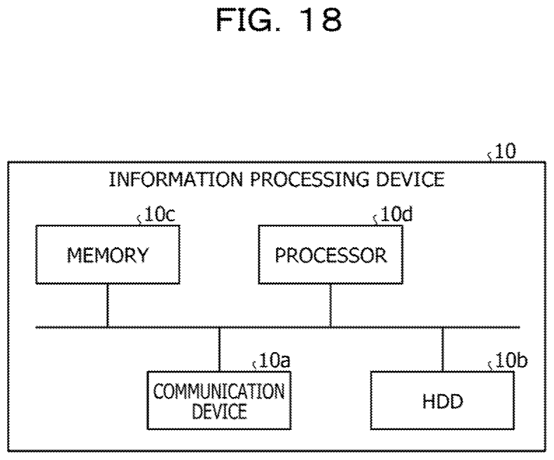

FIG. 18 is a diagram explaining a hardware configuration example. As illustrated in FIG. 18, the information processing device 10 includes a communication device 10a, a hard disk drive (HDD) 10b, a memory 10c, and a processor 10d. In addition, the respective units illustrated in FIG. 18 are mutually coupled by a bus or the like.

The communication device 10a is a network interface card or the like and communicates with another device. The HDD 10b stores programs and databases (DBs) that operate the functions illustrated in FIG. 5.

The processor 10d reads a program that executes processing similar to the processing of each processing unit illustrated in FIG. 5 from the HDD 10b or the like and loads the read program into the memory 10c, thereby operating a process that executes each function described with reference to FIG. 5 or the like. For example, this process executes a function similar to the function of each processing unit included in the information processing device 10. For example, the processor 10d reads a program having functions similar to the functions of the machine learning unit 21, the projection unit 22, the pseudo-domain generation unit 23, the display control unit 24, the analysis unit 25, and the like from the HDD 10b or the like. Then, the processor 10d executes a process of executing processing similar to the processing of the machine learning unit 21, the projection unit 22, the pseudo-domain generation unit 23, the display control unit 24, the analysis unit 25, and the like.

In this manner, the information processing device 10 operates as an information processing device that executes a generation method by reading and executing a program. In addition, the information processing device 10 can also implement functions similar to the functions in the embodiments described above by reading the program described above from a recording medium with a medium reading device and executing the read program described above. Note that other programs referred to in the embodiments are not limited to being executed by the information processing device 10. For example, the embodiments can be similarly applied also to a case where another computer or server executes the program, or a case where such computer and server cooperatively execute the program.

This program can be distributed via a network such as the Internet. In addition, this program can be recorded on a computer-readable recording medium such as a hard disk, flexible disk (FD), compact disc read only memory (CD-ROM), magneto-optical disk (MO), or digital versatile disc (DVD) and executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a generation program for causing a computer to execute a process comprising:
with data included in each of a plurality of data sets, training a feature space in which a distance between pieces of the data included in a same domain is shorter and the distance of the data between different domains is longer; and
generating labeled data sets by integrating labeled data included within a predetermined range in the trained feature space, among a plurality of pieces of the labeled data.

2. The non-transitory computer-readable recording medium according to claim 1, wherein the plurality of data sets is a plurality of unlabeled data sets that are constituted by unlabeled data and have domains different from each other, and
the training includes acquiring a plurality of pieces of data from each of the plurality of data sets, and training the feature space in which the distance between the pieces of the data included in the same domain is shorter and the distance of the data between the different domains is longer, among the plurality of the pieces of the data.

3. The non-transitory computer-readable recording medium according to claim 1, wherein the training includes executing machine learning of a generation model that generates features from input data so as to generate the feature space in which the distance between the pieces of the data included in the same domain is shorter and the distance of the data between the different domains is longer, and
the generating includes using the trained generation model to generate the features for each of the plurality of the pieces of the labeled data that have domains different from each other, and generating the labeled data sets by integrating the labeled data of which the features are included within the predetermined range, among the features for each of the plurality of the pieces of the labeled data, in the trained feature space.

4. The non-transitory computer-readable recording medium according to claim 1, for causing the computer to execute the process comprising projecting the plurality of the pieces of the labeled data into the trained feature space, wherein
the generating includes selecting an arbitrary point from the trained feature space in which the plurality of the pieces of the labeled data is projected, and generating the labeled data sets obtained by integrating a predetermined number of the pieces of the labeled data located within a predetermined distance from the arbitrary point.

5. The non-transitory computer-readable recording medium according to claim 1, for causing the computer to execute the process comprising projecting the plurality of the pieces of the labeled data into the trained feature space, wherein
the generating includes selecting a plurality of points that are arbitrary from the trained feature space in which the plurality of the pieces of the labeled data is projected, and generating each of the labeled data sets that correspond to each of the plurality of points, by acquiring and integrating a predetermined number of the pieces of the labeled data located within a predetermined distance from the selected points, for each of the plurality of points.

6. The non-transitory computer-readable recording medium according to claim 1, for causing the computer to execute the process comprising: projecting the plurality of the pieces of the labeled data into the trained feature space; and
projecting respective pieces of object data of an unlabeled data set that corresponds to a first domain into the trained feature space, wherein
the generating includes generating the labeled data sets that correspond to a pseudo-domain of the first domain, by integrating the labeled data located within a predetermined distance from the respective pieces of object data in the trained feature space in which the plurality of the pieces of the labeled data is projected.

7. The non-transitory computer-readable recording medium according to claim 1, for causing the computer to execute the process comprising:
selecting a set of the labeled data sets whose overlapping spaces are equal to or less than a threshold value and whose coverage in the trained feature space is equal to or higher than the threshold value, from among a plurality of the labeled data sets generated by using the trained feature space; and
executing an analysis related to accuracy of a classification model, by using the selected set of the labeled data sets.

8. The non-transitory computer-readable recording medium according to claim 1, for causing the computer to execute the process comprising:
selecting the labeled data sets generated based on a first data set, from among a plurality of the labeled data sets generated by using the trained feature space; and
executing an analysis related to accuracy of a classification model, by using the first data set and the selected labeled data sets.

9. A generation method comprising:
with data included in each of a plurality of data sets, training a feature space in which a distance between pieces of the data included in a same domain is shorter and the distance of the data between different domains is longer; and
generating labeled data sets by integrating labeled data included within a predetermined range in the trained feature space, among a plurality of pieces of the labeled data.

10. An information processing device comprising:
a memory; and
a processor coupled to the memory and configured to:
with data included in each of a plurality of data sets, train a feature space in which a distance between pieces of the data included in a same domain is shorter and the distance of the data between different domains is longer; and
generate labeled data sets by integrating labeled data included within a predetermined range in the trained feature space, among a plurality of pieces of the labeled data.
